(19) United States
(12) Patent Application Publication
(10) Pub. No.: US 2002/0131409 A1
(43) Pub. Date: Sep. 19, 2002

(54) Self-healing multi-level telecommunications network

(76) Inventors: David L. Frank, Highland Beach, FL (US); Michael J. Blahnik, Boca Raton, FL (US)

Correspondence Address: GARDNER, CARTON & DOUGLAS, PATENT DOCKET DEPT., 321 N. CLARK STREET - SUITE 3400, CHICAGO, IL, 60610, US

(21) Appl. No.: 09/805,792

(22) Filed: Mar. 13, 2001

(51) Int. Cl. H04L 12/50

(52) U.S. Cl. 370/386; 370/389

(57) ABSTRACT

The present invention relates to a high-speed, wireless, redundant telecommunications network that provides network flexibility and greater utilization of network resources. The system and method of the present invention provides a self-healing network capable of routing PCS/cellular voice traffic within industry acceptable standards. The network design of the present invention is based upon wireless technology incorporating the ATM protocol and provides for a multi-level network wherein each level aggregates bandwidth from the previous level. The self-healing network of the present invention eliminates backhaul, delivers high bandwidth capacity and reliably supports a high quality voice broadband network in a cost efficient manner.

### FIELD OF INVENTION

The present invention relates generally self-healing telecommunications networks. More particularly, the present invention discloses and claims to a system and method for routing PCS/cellular voice traffic through a multi-level telecommunications network.

### BACKGROUND OF THE INVENTION

A primary concern when designing and implementing a voice-quality telecommunications network is providing a reliable pathway between remote network nodes and the central office of the network. When the telecommunication network is designed to provide for high quality telephony such as PCS/cellular in a dynamic environment, i.e., with constantly increasing number of customers and constantly changing technologies, the demands of the network are magnified. In order to provide an acceptable quality of service, such a network must be highly reliable and completely redundant, i.e., the network must be able to instantaneously restore itself from failure. Moreover, the network must connect the most distant cellular towers to the central office within an industry acceptable amount of time, i.e., within 60 msec. Most telecommunications networks adapted to provide high quality voice transmissions are comprised of redundant transmission pathways and hardware and a single server or resource manager. In the event of a partial network failure, the single server or resource manager must reroute all calls to the central office, thereby monopolizing limited network resources. Consequently, when there are several cell towers “off-line,” requests for rerouting the network traffic must be queued and voice quality may be lost due to the time needed to reroute the queued calls. Additionally, if a single server is responsible for re-routing all network traffic, expanding the number of nodes within the network generally requires additional programming of the software and/or a substantial investment of redundant hardware.

Conventional telecommunications networks for voice quality transmissions either do not have self-healing infrastructures between two specific nodes which causes information to be lost in the event of a partial system failure, or provide for complete redundant corrections. While redundant network designs offer high-speed recovery control, the network topology requires two sets of hardware and duplicate communication links, resulting in increased costs for the additional hardware, and lost revenue potential from the redundant communication links. Moreover, current telecommunications networks that require the fixed redundancies to each remote tower are not readily expandable at low cost.

Some wireless networks are point-to-point systems, often transmitting in the unlicensed frequency bands, while other networks are point-to-multipoint systems, i.e., they transmit in a star cluster. These star cluster transmissions generally utilize licensed spectra, usually LMDS, to avoid interference. These types of networks are highly redundant and/or lose a significant number of calls.

### SUMMARY OF THE INVENTION

The present invention relates to a high-speed, wireless, redundant telecommunications network that provides for network flexibility and a greater utilization of network resources. The system and method of the present invention allows for a self-healing network capable of handling PCS/cellular voice traffic within industry acceptable standards.

The present network invention is based on a set of wireless Asynchronous Transfer Mode (“ATM”) technologies that provide concentration nodes with an extended wireless broadband ring. The network design of the present invention responds to the need for increased bandwidth utilization of telecommunication links, a reduction of network failures, including dropped calls in the PCS/cellular environment, more optional utilization of equipment, enhanced network reliability, and increased network manageability and surveillance. The present invention, in a preferred embodiment, provides for a wireless network that can carry seamless voice transmissions and is adaptable to new technologies such as 2G and 3G. The wireless, independent network of the present invention is comprised of groups of nodes connected into rings where the groups of nodes are arranged into hierarchical levels. In the multi-level network, a group of nodes at a particular level aggregates bandwidth from one or more groups of nodes from a more remote level, i.e., a level that is further from the central office. Each group of nodes is provided with alternative paths to two different groups that are located closer to the central office, thus providing for a flexible, inherently redundant network that more optimally utilizes the network itself and its equipment.

In one embodiment of the present invention, each node has two microwave paths within the group. The pathways are managed by an ATM switch at each node. The ATM switches and use of the ATM/PNNI (“Private Network to Network Interface”) protocol allows for network routing decisions to be made at the individual nodes instead of from a central office. By providing for a self-healing network that provides for inherent redundancy, but without redundant equipment, the present invention provides for a reliable network capable of maintaining the integrity of cellular/PCS the original calls while eliminating or minimizing dropped calls.

While the network connections of a preferred embodiment of the present invention consist of licensed frequency microwave, the network may be deployed using other well-known transmission means such as fiber optics. The network provided by the present invention is readily adaptable to changes in network capacity without redesigning the entire network. As shown in the preferred embodiments, the present invention provides a voice grade network while delivering the required amount of bandwidth to each and every node in the network. Further, the independent network of the present invention eliminates backhaul, delivers high bandwidth capacity and reliably supports a high quality voice broadband network in a cost-effective manner.

### BRIEF DESCRIPTION OF THE DRAWINGS

FIG. 1 is a simplified network design according to the present invention.

FIG. 2 is a block diagram illustrating the self-healing aspects of the present invention.

FIG. 3 depicts the hardware required at each cell tower according to the present invention.

FIG. 4 is an enhanced network design according to the present invention.

### DETAILED DESCRIPTION OF THE INVENTION

The network of the present invention is best explained in terms of a preferred embodiment. Such an embodiment encompasses a wireless network using ATM/PNNI communication protocol. The present invention is readily adapted for use with other ATM-like communication protocols. In fact, if other communication protocols such as TCP/IP or Frame Relay can be adopted to provide voice-quality broadband transmissions, the present invention could be adaptable to those protocols as well. The present invention utilizes licensed microwave frequencies as its communications means, to ensure network reliability. The present invention can be adapted for other transmissions means such as fiber optics, although some of the cost-savings would not be realized. While other RF transmissions means are encompassed by the invention, including the use of unlicensed microwave or higher frequencies (e.g., U-NII band frequencies), these solutions may decrease the almost 100% reliability of the network of the present invention.

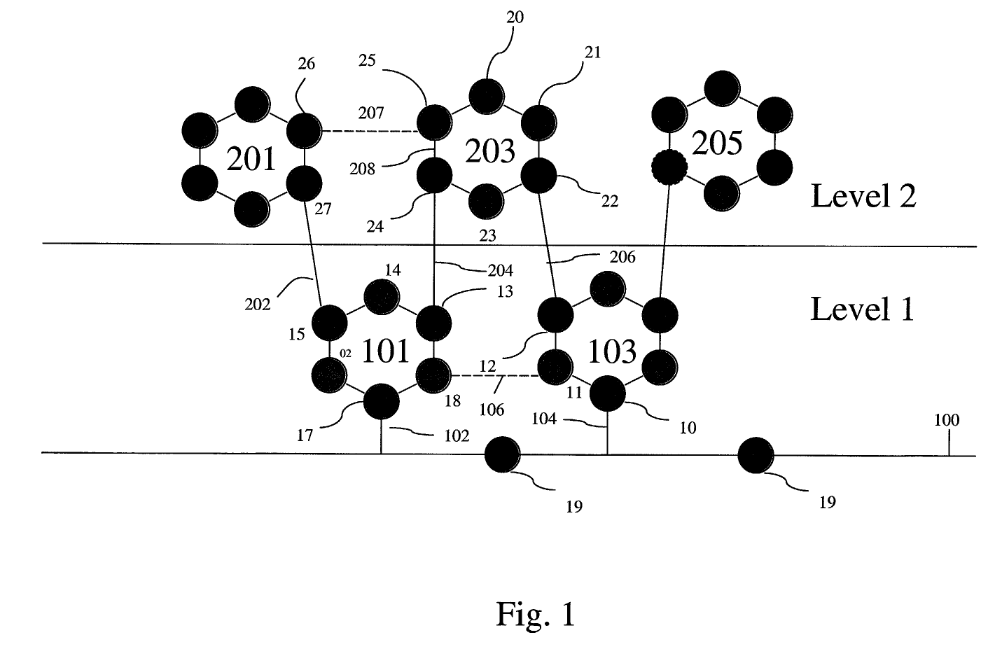

FIG. 1 depicts a simplified network design of the present invention according to a preferred embodiment that is adapted to provide an expandable network to handle PCS/cellular telephone calls. Each node in the network, i.e., 20, 21, 22, is a cell tower that aggregates cellular/PCS communications from a particular geographic area. The present invention provides for the transmission of a cellular/PCS communications from any cell tower to a central office 19 on the fiber backbone 100. In the present invention, four to six cell towers in close proximity to one another are arranged into rings or groups, i.e., 201, 203, 205. Each node within a group is linked via the communication means, such as licensed microwave frequencies with an adjacent node. Since each node has communication links with two adjacent nodes, for example node 21 is linked to both node 20 and 22, each group is a self-healing, inherently redundant mininetwork. In other words, there is always a second communications pathway to carry PCS/cellular communications within each group, so calls are not lost if the communications link between a pair of adjacent nodes is lost.

As shown in FIG. 1, groups in Level 2, must be linked with groups in Level 1, which in turn communicate with the fiber backbone and the central office. For example, in FIG. 1, group 203 communicates with group 101 through communications link 204 at inter-level nodes 13 and 24. The PCS/cellular communications then proceed through group 101 until it reaches node 17 which has a direct communication link 102 with the fiber backbone 100. If the inter-level communication link 204 fails, group 203 communicates with group 103 through communications link 206 between inter-level nodes 12 and 22. The PCS/cellular communications then proceeded through group 103 until it reaches node 10 which has a direct communications link 104 with the fiber backbone 100. By providing two inter-level connections, there is always a second pathway to the fiber backbone from group 103, i.e., there is inherent redundancy within the network. To provide additional flexibility within the network, the groups within a given level are connected with other groups within the same level. For example, in FIG. 1, groups 201 and 203 communicate through an intra-level communication link 207 between nodes 25 and 26. When a voice communication is initiated, the network creates the connection via the best-route available. When a failure occurs in the network, the call is rerouted via the alternate best-route path.

Referring to FIG. 1, each group is built based on proximity and capacity of individual cell towers to each other and their relationship to adjoining groups. The number of towers in each group is based in part upon the amount of bandwidth required by each tower within the group and upon the “transient” capacity that the group may have to transmit due to bandwidth aggregations from other groups. For example, within group 203, nodes 24 and 25 are interconnected via communications link 208 that must accommodate the total planned capacity of the group, plus any “transient” capacity from another group, e.g., 201, that may pass through in the event of a failure of a communications link in the planned best path from that other group. For example, group 203 will carry “transient” capacity from group 201 if there is a failure of communications link 202. The groups are interconnected using increasingly higher capacity transit links to carry the traffic from the outer groups to the fiber backbone. Inter-level communication links such as 204 and 206 must be capable of handling the aggregate capacity of all of the groups for which it could provide connectivity to the fiber backbone. Similarly, the communication links between nodes of any given groups must be able to carry the aggregate bandwidth of all of the groups which may aggregate into its group.

In designing the system of the present invention, each group must be connected by at least two communication links to different adjoining groups in order to allow for efficient traffic flow through the network. Inter-group communication links are located at points within the group that allow for the balanced capacity movement of the traffic, while allowing redundancy in the event of a cell or network component failure. In a balanced network, the inter-group communication links are placed at opposite ends of the group. Assuming the network shown in FIG. 1 is balanced, then the inter-level communication links 204 and 206 would be designated to carry half of capacity of group 203. Bandwidth capacity from the left side of group 203 would flow to cell 101 through inter-level communications link 204, while bandwidth capacity from the right side of group 203 would flow through communication link 206 to group 103. If the communications link 204 fails or a network component failure impedes routing to or through group 101, the capacity from the left side of group 103 may be automatically re-routed through communications link 206 to cell 103. If there is a communications failure within group 203, only bandwidth from those nodes that cannot route via the best path originally designed into the network system would be automatically routed in the opposite direction, i.e., via the new best path available.

As traffic flows through each level of the network, the network automatically adjusts to unusual events to ensure the traffic is delivered with minimal delay. This is accomplished by utilizing carrier class protocols, such as ATM/PNNI and equipment and through an efficient original network design that accounts for the capacity of each node and each group. As described in the example above, unusual events within the network will only affect a small number of groups or isolate itself within a group without impacting adjoining groups.

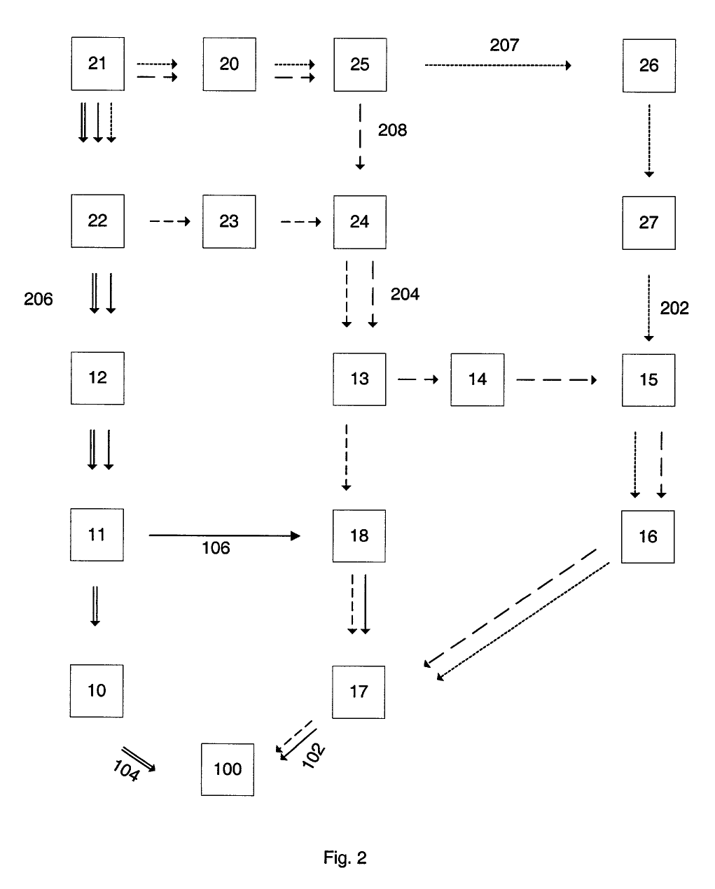

The self-healing nature of the network of the present invention is readily understood with reference to the block diagram of FIG. 2. The reference numbers in FIG. 2 refer to the cell tower of FIG. 1. Assuming a PCS call connects in to cell tower 21, the [symbol] arrows in FIG. 2 show that the network designed best path routes the call from cell tower 21 to cell tower 22 to cell tower 12 to cell tower 11 to cell tower 10, which has a direct communications link with the fiber backbone 100 and a central office 19. However, if cell tower 10 is not functioning, the PCS call is immediately routed according to the → arrows in FIG. 2, i.e., the call is routed from cell tower 21 to cell tower 22 to cell tower 12 to cell tower 11 to cell tower 18 to cell tower 17 and the fiber backbone. If, instead cell tower 12 is down, the call may be routed as shown --> arrows in FIG. 2: cell tower 21 to cell tower 22 to cell tower 23 to cell tower 24 to cell tower 13 to cell tower 18 to cell tower 17 and the fiber backbone. Additional potential routes, shown by the . . . and - - - in FIG. 2, depict alternate best paths when cell tower 22 is off-line.

FIG. 2 graphically demonstrates that the present invention provides for a self healing network that approximates a redundant network when viewed from any given cell tower. Moreover, because routing decisions are made according to the ATM/PNNI protocol at the individual nodes and not by a central office, the time required for the selection of the best path available is almost instantaneous. The self-healing nature of the network provides for the constant utilization of network equipment, while still providing an inherently redundant network.

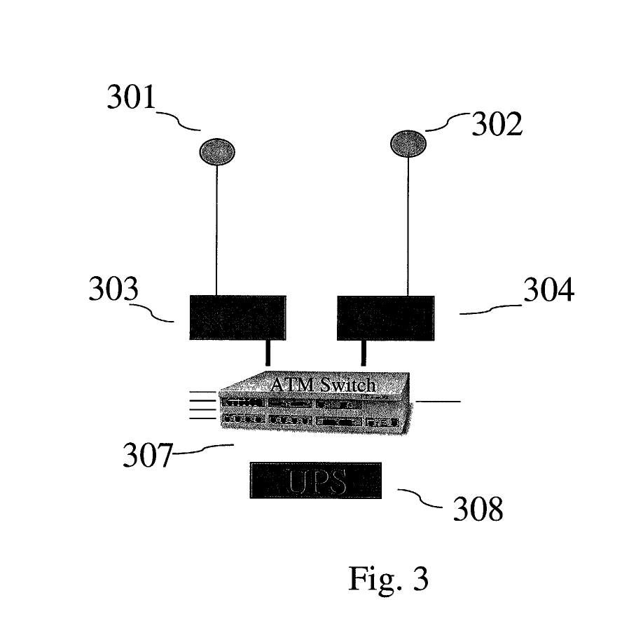

FIG. 3 illustrates the network hub configuration at each cell tower, e.g., 10, 12. Each cell tower is equipped with an ATM switch 307 and at least two transceivers 303, 304. Each transceiver 303, 304 communicates with its respective cell tower antenna 301, 302. Consequently, bandwidth aggregated at any cell tower has at least two, i.e., a primary, or best path route, and an inherently redundant, or alternate best path route, to the central office. The telecommunications link at each cell tower is managed by an ATM switch 307. The ATM switch 307 at each cell tower is configured for maximum redundancy. The ATM switch at a cell tower which serves as a primary node, i.e., provides for an inter-group telecommunications link, is a fully redundant dual processor device, and makes network routing decisions. The ATM switch further provides local interfaces to existing network equipment at the tower. Back-up power 308 is supplied at each cell tower site.

Cell towers are grouped to provide for minimum delays and optimal aggregation of bandwidth. The number of cell towers in each group is defined by group bandwidth capacities and network delay considerations. As the cell towers transmit their respective traffic on the group, the aggregate bandwidth within the group is compounded. The transmissions times for each group and the time it takes to route traffic through the ATM switch 307 both add up to the total latency time for each cell call connection. The estimated latency times for each of the network components is approximately 3.0 msec at the group and approximately 250 msec. at the ATM switch. In order to ensure optimal voice quality, the total latency time from the most remote cell tower to the central office must be less than 60 msec. Therefore, when designing an optimal network according to this invention, there should be more than four hops, i.e., node-to-node connections from any Level 1 tower to the fiber backbone and no more than seven hops from any Level 2 tower to the fiber backbone.

Referring back to FIG. 1, at cell tower 20 for example, cell towers antennae 301 and 302 communicate with their respective cell towers antennae 301′ and 302′ (not shown) located at cell towers 21 and 25. The cell tower antennae located at cell tower 25 both route traffic around group 203 and, possibly, accepts backhaul from group 201. At least two transceivers are located at each cell tower. However, at inter-group cell towers such as 25, three transceivers are required, two for the cell tower traffic and one for the backhaul traffic.

At each Level, varying capacity equipment is required. For example, because the bandwidth is aggregated at each Level, if voice data is transmitted at Level 2 at DS3 and the voice data aggregated at Level 1 is being transmitted at OC3, higher capacity equipment is required at each cell tower at Level 1.

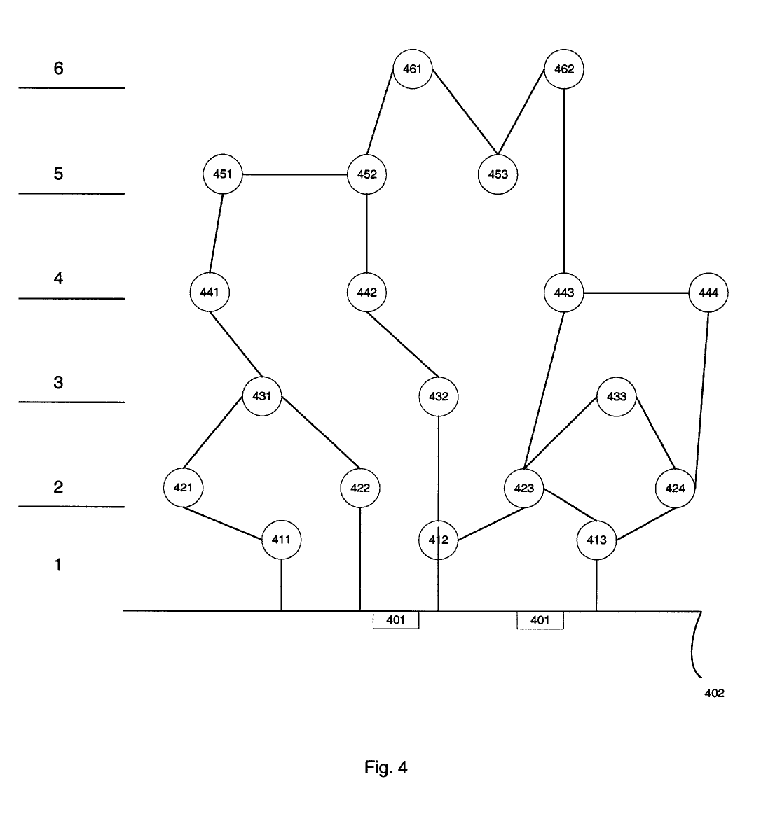

FIG. 4 depicts a six-level network encompassed within the present invention. In FIG. 4, the reference numbers refer to groups, i.e. groups of four to six cell towers. According to FIG. 4, the aggregation of bandwidth, may not at all times be linear, i.e., based on the topography of the system and/or imbalances in the capacities of the various groups, one group may be aggregated by a group in a non-successive level. For example, in FIG. 4, group 462 communicates directly with group 443. Similarly group 444 may be aggregated directly into group 424. As shown in FIG. 4, a second level group such as 422 may interface directly with the fiber backbone.

While this invention has been described with specific embodiments, many alternatives, modifications and variations will be apparent to those skilled in the art in light of the foregoing description. Accordingly, it is intended to include all such alternatives, modifications and variations set forth within the sprint and scope of the description.

What we claim is:

1. A method of routing a communication transmission from a remote location to a central location comprising the steps of:
a) providing a first plurality of adjacent communication nodes on a first network level, the nodes forming a first group and having at least one first inter-level communication node;
b) providing a second plurality of adjacent communication nodes on a second network level, the nodes forming a second group and having at least second and third inter-level communication nodes;
c) routing the communication transmission through adjacent communication nodes in the first group on the first network level until the transmission reaches the first inter-level communication node;
d) transmitting the communication transmission via the first inter-level communication node to the second inter-level communication node;
e) routing the communication transmission through adjacent communication nodes in the second group on the second network level until the transmission reaches the third inter-level communication node; and
f) routing the communication transmission via the third inter-level communication node to the central location via a fiber backbone.

2. The method of claim 1 wherein the second network level is adapted to aggregate bandwidth from the first network level.

3. The method of claim 1 wherein the communication transmission is routed between adjacent communication nodes and between network levels via wireless transmission means.

4. The method of claim 1 wherein the wireless transmission means comprises microwave connections based on licensed bands to avoid frequency interference.

5. The method of claim 1 wherein the network infrastructure is based upon ATM technology.

6. The method of claim 1 wherein each network level comprises a plurality of groups.

7. The method of claim 1 wherein each group forms a self-healing network ring.

8. A communications network comprising:
a) a plurality of adjacent communication nodes interconnected by first communication links to form a plurality of adjacent ring-like groups;
b) second communication links connecting at least one communication node from each group to at least one communication node in the adjacent group;
c) at least two input/output means located within each node;
d) a network decision making means located within each node, the decision making means in communication with the input/output means; and
wherein the plurality of groups are divided into hierarchical network levels, each level comprising at least two groups and wherein each higher network level group has two inter-level communication nodes in direct communication to two independent inter-level communication nodes on lower level groups.

9. The communications network of claim 8 further comprising three input/output means located at each inter-level communication node.

10. The communications network of claim 8 wherein each node is in wireless communication with an adjacent node.

11. The communications network of claim 10 wherein the wireless communications are microwave connections based on licensed bands to avoid frequency interference.

12. The communications network of claim 8 wherein the input/output means is a transceiver.

13. The communications network of claim 8 wherein the network decision making means is an ATM switch configured for maximum redundancy.

14. The communications network of claim 8 wherein each node has at least two paths into the network.

15. The communications network of claim 8 wherein each network component has a transmission latency time of approximately 3.0 msec.

16. A method of designing a network comprising the steps of:
a) providing a plurality of communication nodes;
b) dividing the plurality of communication nodes into a plurality of groups;
c) connecting the nodes within each group via a first transmission means;
d) dividing the plurality of groups into a plurality of hierarchical network levels;
e) interconnecting the plurality of groups on each network level via a second transmission means;
f) interconnecting each of the plurality of groups on a higher network level with a specific group on a lower level via a third transmission means;
g) interconnecting each of the groups on the lower level with a central location; and
wherein each higher network level group has two inter-level communication nodes in direct communication with two independent inter-level communication nodes on lower level groups.

17. The method of claim 16 wherein each hierarchical level is adapted to aggregate bandwidth from the previous level.

18. The method of claim 16 wherein the first transmissions means is an intra-group communications links.

19. The method of claim 16 wherein the second transmission means is an intra-level communications link.

20. The method of claim 16 wherein the third transmission means is an inter-level communications link.

21. The method of claim 16 wherein the network infrastructure is based on ATM technology.

22. The method of claim 16 wherein each group forms a self-healing network ring.

23. The method of claim 16 wherein each of the communication nodes within a group is in contact with at least one adjacent node.

24. A method of restoring a self-healing network comprising the steps of:
a) providing a first plurality of adjacent communication nodes on a first network level, the nodes forming a first group and having at least one first inter-level communication node;
b) providing a second plurality of adjacent communication nodes on a second network level, the nodes forming a second group and having second and a third inter-level communication nodes;
c) routing a communication transmission to adjacent communication nodes on the first network level along the best path available;
d) detecting a node failure;
e) identifying the component or communication link involved in the node failure;
f) communicating between adjacent nodes to find the best available path available;
g) selecting the alternative route for the communication transmission;
h) re-routing the communication transmission until the transmission reaches the first inter-level communication node;
i) transmitting the communication transmission via the first inter-level communication node to the second inter-level communication node;
j) routing the communication transmission around adjacent nodes on the second network level until the transmission reaches the third inter-level communication node; and
k) routing the communication transmission via the third inter-level communication node to the central location via a fiber backbone.
